(19) United States
(12) Patent Application Publication
(10) Pub. No.: US 2003/0011930 A1
(43) Pub. Date: Jan. 16, 2003

(54) Write element having a narrow writer pole defined by ion implantation

(76) Inventors: William J. O'Kane, Derry (IE); Brian L. Kelly, Derry (IE)

Correspondence Address: Brian D. Kaul, WESTMAN CHAMPLIN & KELLY, International Centre - Suite 1600, 900 South Second Avenue, Minneapolis, MN, 55402-3319, US

(21) Appl. No.: 10/054,272

(22) Filed: Jan. 22, 2002

Related U.S. Application Data
(60) Provisional application No. 60/305,685, filed on Jul. 16, 2001.

(51) Int. Cl. G11B 5/127

(52) U.S. Cl. 360/125

(57) ABSTRACT

A write element includes a return pole that is separated from a writer pole by a writer gap layer. The writer pole has a width and a magnetically active region adjoining a first magnetically dead side wall. The magnetically active region defines a track width of the write element, which is less than a width of the writer pole.

### CROSS-REFERENCE TO RELATED APPLICATION

The present invention claims priority to U.S. Provisional Application No. 60/305,685, filed on Jul. 16, 2001 for inventors William J. O'Kane and Brian L. Kelly and entitled “TOP POLE TRACK WIDTH CONTROL VIA ION IMPLANTATION.”

### FIELD OF THE INVENTION

The present invention relates to a write element for use with disc drive storage systems. More particularly, the present invention relates to a write element having a narrow writer pole and a method of forming the same.

### BACKGROUND OF THE INVENTION

Thin film magnetic read/write heads, such as magnetoresistive (MR) and giant magnetoresistive (GMR) read/write heads are commonly used in disc drive storage systems. These read/write heads typically include separate read and write elements for reading data from and writing data to a magnetic recording medium, such as a magnetic disc. One advantage to this configuration is that the read and write elements can be optimized for the particular task they are to perform.

The write element of the read/write head generally includes a conductor coil, a bottom pole, and a top pole separated from the bottom pole by a writer gap. In operation, the top and bottom poles have pole tips at an air bearing surface that face, and are in close proximity to, the rotating magnetic disc. During a write operation, an electrical current is caused to flow in the conductor coil, which induces a magnetic field that is conducted through magnetically active regions of the top and bottom poles and into a recording layer of the magnetic disc that contains magnetic moments. Each of the magnetic moments have an orientation that is representative of a bit of data.

Either the top or bottom pole operates as a writer pole whose magnetically active region is defined as the portion of the writer pole at the pole tip through which the density of the magnetic field that is conducted exceeds a coercivity of the recording layer and can cause the magnetic moments of the recording layer to orient themselves in the direction of the magnetic field. In other words, the magnetic field that is conducted through the magnetically active region of the writer pole can be used to write data to the magnetic disc. Typically, the top pole is designed to operate as the writer pole and the bottom pole is designed to operate as a return pole. The return pole typically has a much larger cross-sectional area than the writer pole to thereby reduce the density of the magnetic field conducted therethrough such that it is less than the coercivity of the recording layer to ensure that the magnetic field extending between the recording layer and the return pole has a density that will not cause data recorded on the recording layer to be overwritten.

There is a never ending demand for higher data storage capacity in disc drives. One measure of the data storage capacity is the areal density of the bits at which the disc drive is capable of reading and writing. The areal density is generally defined as the number of bits per unit length along a track (linear density in units of bits per inch) multiplied by the number of tracks available per unit length in the radial direction of the disc (track density in units of track per inch or TPI). Currently, there is a need for areal densities on the order of 100 Gb/in²which requires a track density on the order of 100-200 kTPI and greater.

One limiting factor to the track density at which a disc drive is capable of operating, is the track width within which data can be written by the write element. The track width of the write element can be approximated to a first order by the physical width of the magnetically active region of the writer pole. Magnetically active regions of writer poles of the prior art are defined by the physical structure of the writer pole since it is formed entirely of magnetic conductive material. Consequently, the track width of the writer pole is defined by the physical width of the writer pole at the pole tip. Thus, the track width that can be achieved for these prior art write elements is limited to the processing techniques used to form the writer pole structure. Unfortunately, the above-mentioned track density demands generally require the writer poles to be accurately formed with widths in the sub-micron (μm) range or on the order of 0.1 to 0.2 μm. These constraints push the resolution capabilities of conventional processing techniques, such as photolithography, milling, electroplating, and etching, thereby making it extremely difficult to pattern such narrow writer poles. For example, the writer pole structures that can be accurately formed using conventional photolithographic techniques are on the order of approximately 0.2 μm.

Therefore, a continuing need exists for write elements and methods for forming write elements having narrow track widths.

### SUMMARY OF THE INVENTION

The present invention provides a writer pole of a write element whose track width is reduced beyond its physical width thereby allowing for track widths that are narrower than the resolution capabilities of current physical processing techniques. One aspect of the present invention is directed to a method of manufacturing such a writer pole. In the method, a writer pole portion is formed on a non-magnetic layer. The writer pole portion includes first and second side walls which initially define a width of a magnetically active region. Finally, the first side wall is transformed into a magnetically dead side wall thereby reducing the width of the magnetically active region and the track width of the write element by a thickness of the magnetically dead side wall. In accordance with another embodiment of the invention, the second side wall is also transformed into a magnetically dead side wall to further reduce the width of the magnetically active region.

Also disclosed is a write element for use in a head of a disc drive storage system having a narrow track width. The write element includes a return pole that is separated from a writer pole by a writer gap layer. The writer pole has a width and a magnetically active region adjoining a first magnetically dead side wall. The magnetically active region defines the track width of the write element, which is less than a width of the writer pole.

Additional features and benefits of the present invention will become apparent with the careful review of the following drawings and the corresponding detailed description.

### BRIEF DESCRIPTION OF THE DRAWINGS

FIG. 1 is a top view of a disc drive storage system with which embodiments of the present invention may be used.

FIG. 2 shows a top view of a write element of a read/write head.

FIG. 3 is a cross-sectional view of the write element of FIG. 2 as seen in plane 3-3.

FIGS. 4 and 5 are partial cross-sectional views of a write element as seen in plane 4-4 of FIG. 2 in accordance with embodiments of the invention.

FIGS. 6.1-6.4 show partial cross-sectional views of a write element as seen in plane 4-4 of FIG. 2 which illustrate manufacturing steps of in accordance with an embodiment of the invention.

### DETAILED DESCRIPTION OF ILLUSTRATIVE EMBODIMENTS

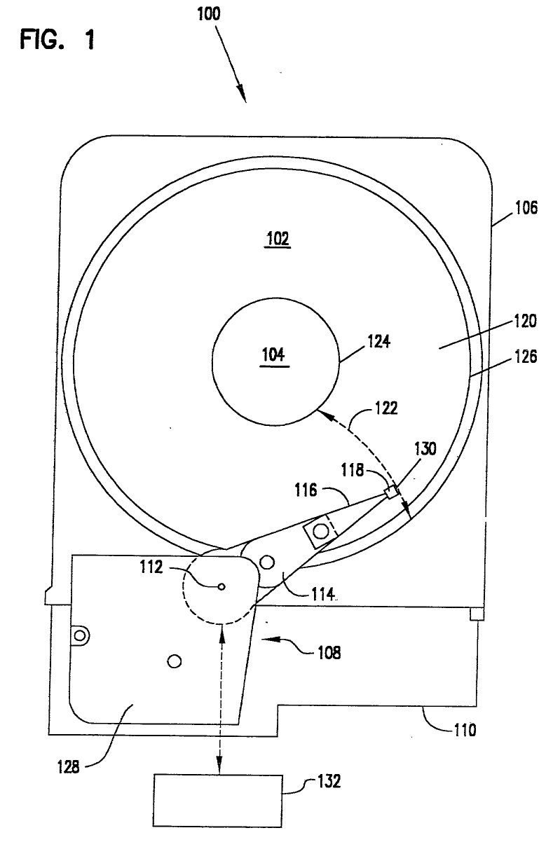

FIG. 1 is a top view of a disc drive 100, with which embodiments of the present invention may be used. Disc drive 100 includes a magnetic disc 102 mounted for rotational movement about an axis 104 and driven by spindle motor (not shown). The components of disc drive 100 are contained within a housing that includes base 106 and a cover (not shown). Disc drive 100 also includes an actuator 108 mounted to a base plate 110 and pivotally moveable to disc 104 about axis 112. Actuator mechanism 108, includes actuator arm 114 and suspension assembly 116. Slider 118 is coupled to suspension assembly 116 through a gimbaled attachment which allows slider 118 to pitch and roll as it rides on an air bearing above surface 120 of disc 102. Actuator mechanism 108 is adapted to rotate slider 118 on arcuate path 122 between an inner diameter 124 and an outer diameter 126 of disc 102. A cover 128 can cover a portion of actuator mechanism 108. Slider 118 supports a head 130 having separate read and write transducing elements for reading information from and writing information to disc 102.

During operation, as disc 102 rotates, air (and/or a lubricant) is dragged under air bearing surfaces (ABS) of slider 118 in a direction approximately parallel to the tangential velocity of disc 102. As the air passes beneath the bearing surfaces, air compression along the air flow path causes the air pressure between disc surface 120 and the bearing surfaces to increase, which creates a hydrodynamic lifting force that counteracts a load force provided by suspension 116 and causes slider 118 to “fly” above and in close proximity to disc surface 120. This allows slider 118 to support head 130 in close proximity to the disc surface 120.

Drive controller 132 controls actuator mechanism 108 through a suitable connection. Drive controller 132 can be mounted within disc drive 100 or located outside of disc drive 100. During operation, drive controller 132 receives position information indicating a portion of disc 102 to be accessed. Drive controller 132 receives the position information from an operator, from a host computer, or from another suitable controller. Based on the position information, drive controller 132 provides a position signal to actuator mechanism 108. The position signal causes actuator mechanism 108 to pivot about axis 112. This, in turn, causes slider 118 and the head 130 it is supporting to move radially over disc surface 120 along path 122. Once head 130 is appropriately positioned, drive controller 132 then executes a desired read or write operation.

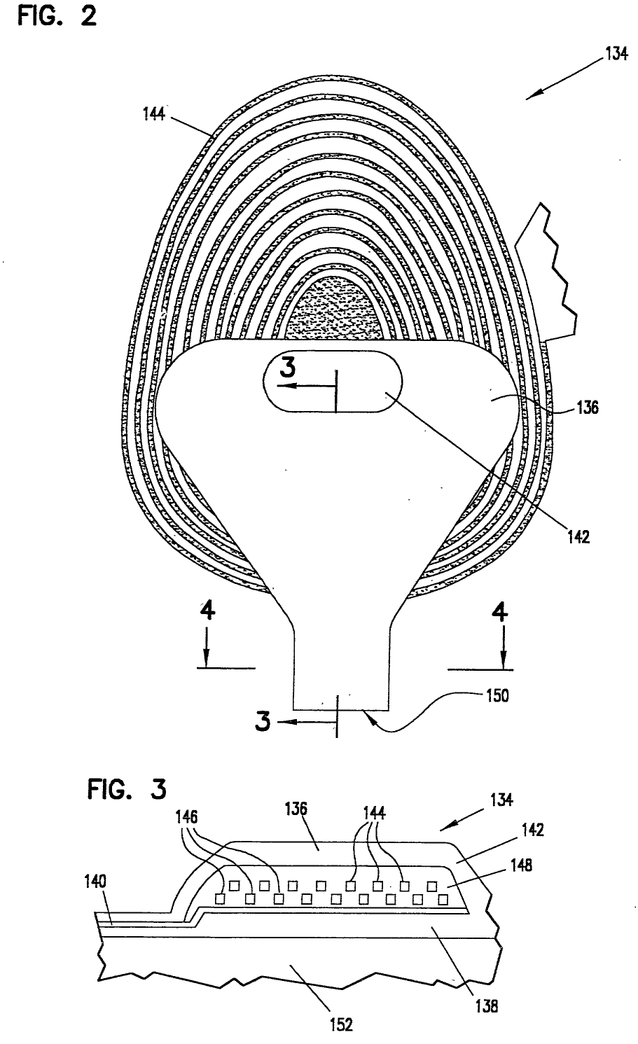

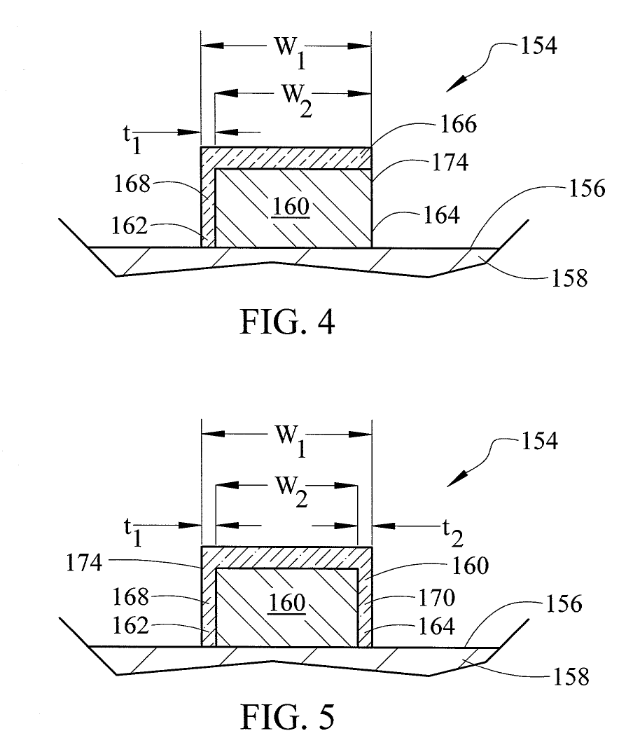

An example of a multi-turn inductive thin film write element 134 of head 130 is shown schematically in FIGS. 2 and 3. FIG. 2 is a top view of write element 134 and FIG. 3 is a cross-sectional view as seen in plane 3-3 of FIG. 2. Write element 134 includes top pole 136 and bottom pole 138, which are separated by a writer gap layer 140. Top and bottom poles 136 and 138 are preferably formed of a magnetic conductive material, such as cobalt-iron (CoFe), cobalt-nickel-iron (CoNiFe), nickel-iron (NiFe), cobalt (Co), or other suitable magnetic conductive material. Top pole 136 and bottom pole 138 contact each other at back gap “via” 142 and form the two poles of write element 134. Conductive coils 144 and 146 extend between top pole 136 and bottom pole 138. An insulating material 148 electrically insulates conductors 144 and 146 from top and bottom poles 136 and 138. Top pole 136, bottom pole 138 and writer gap layer 140 include a pole tip region 150 (FIG. 2) that faces disc surface 120 and forms a portion of the air bearing surface of slider 118. Either top pole 136 or bottom pole 138 can operate as a writer pole while the other operates as a return pole.

The components of write element 134 are deposited upon a nonmagnetic substrate 152, which typically comprises a ceramic composite compound, such as Al₂O₃—TiC. Also, an insulating material, such as an Al₂O₃ base coat (not shown), can separate the substrate 152 and bottom pole 138. A separate read element (not shown) can also be included to form a merged read/write head 130 in accordance with known methods. The read element could be magnetoresistive sensor, a spin valve sensor, or other suitable read element known in the art.

Track widths of write elements of the prior art are generally defined by a width of a magnetically active region of the writer pole (typically the top pole), which matches the physical width of the writer pole at the pole tip. Thus, the track width of these prior art write elements can only be narrowed by narrowing the structure of the writer pole. As a result, the resolution capability of such a write element is limited, in part, to the processing techniques that are used to form the writer pole. The present invention avoids this limitation by providing a writer pole whose magnetically active region is formed narrower than the physical width of the writer pole, thereby avoiding the limitations of the processing techniques used to form the physical structure of the writer pole. As a result, the write element of the present invention can realize higher areal density recordings than were previously achievable by prior art write elements.

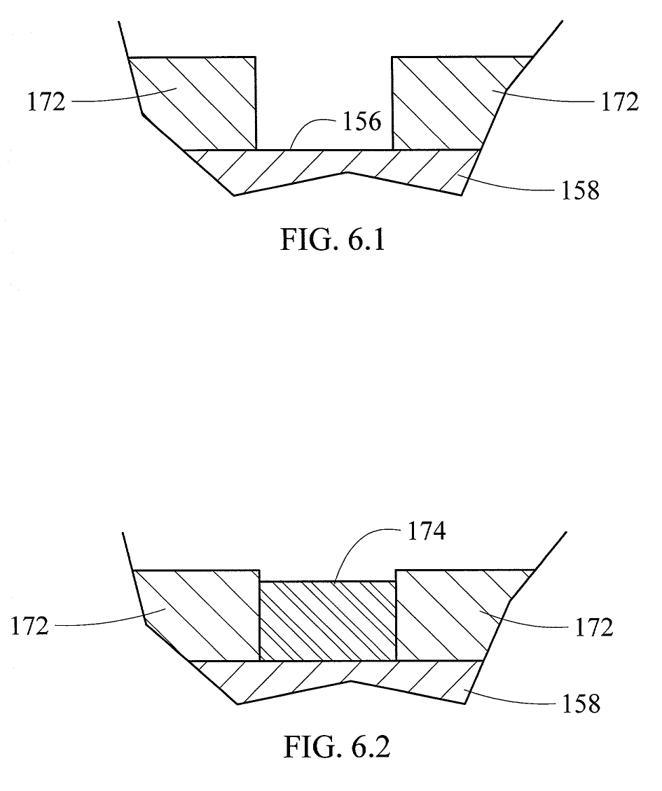

FIGS. 4 and 5 are partial air bearing surface views of write elements 134, taken along line 4-4 of FIG. 2, in accordance with various embodiments of the invention. To simplify the discussion of the invention, the illustrations focus on the writer pole element, generally designated as 154, to which aspects of the present invention are directed. In addition, the drawings are not shown to scale and conventional write element components, such as the return pole and side shields, are also eliminated from the drawings to further simplify the discussion of the invention.

Writer pole 154 of the present invention is formed on a surface 156 of a non-magnetic layer 158, as shown in FIGS. 4 and 5. As mentioned above, it should be understood that either top or bottom pole 136 or 138 can be used as the writer pole 154 of the present invention while the other is used as the return pole. Accordingly, non-magnetic layer 158 could be the writer gap layer 140 when writer element 154 is the top pole 136, or non-magnetic substrate 152 when writer element 154 is the bottom pole 138, all of which are shown in FIG. 3. Writer pole 154 has a physical width W₁ and includes an active region 160 having a width W₂ that defines a track width of the write element 134 and is less than the physical width W of the writer pole 154. The width W₂ of the magnetically active region 160 is reduced by the formation of magnetically dead regions 166. Exterior portions of writer pole 154 are transformed from magnetically active regions into the magnetically dead regions through ion implantation or irradiation of writer pole 154 with selected elements, as will be discussed in greater detail below.

The magnetic permeability of magnetically dead region 166 is substantially less than the magnetic permeability of the magnetically active region 160. The magnetic permeability of the magnetically dead region 166 is reduced to such a level that the write element 134 cannot conduct a magnetic field through the magnetically dead region 166 that exceeds the coercivity of the recording layer. Therefore, during a write operation, only the magnetic field that is conducted through the magnetically active region 160 is of sufficient strength to exceed the coercivity of the recording layer of the recording media, such as disc 102 of FIG. 1, and cause a change in the magnetic moments stored therein. As a result, the width W₂ of the magnetically active region defines the track width of the write element 134 rather than the physical width W₁ of the writer pole 154.

In accordance with one embodiment of the invention, the magnetically dead region 166 covers first side wall 162 of writer pole 154 to form a first magnetically dead side wall 168. as shown in FIG. 4. As a result, the magnetically active region 160 has a width W₂ that is equal to the physical width W₁ of the writer pole 154 less a thickness t₁ of the first magnetically dead side wall 168.

In accordance with another embodiment of the invention, both first and second side walls 162 and 164 are transformed into first and second magnetically dead side walls 168 and 170, respectively, as shown in FIG. 5. This embodiment of the invention provides a further reduction to the width W₂ of active region 160 by a thickness t₂ of the second magnetically dead side wall 170.

The portions of the magnetically active region 160 that are transformed into magnetically dead regions 166 can be controlled using processing techniques, such as overlaying those portions with an insulating/blocking material or directing the irradiation or implantation at one of the side walls. Furthermore, the depth of the resulting magnetically dead regions 166, such as thicknesses t₁ and t₂, can be adjusted by controlling the duration of exposure to the implantation or irradiation process and the energy of the process.

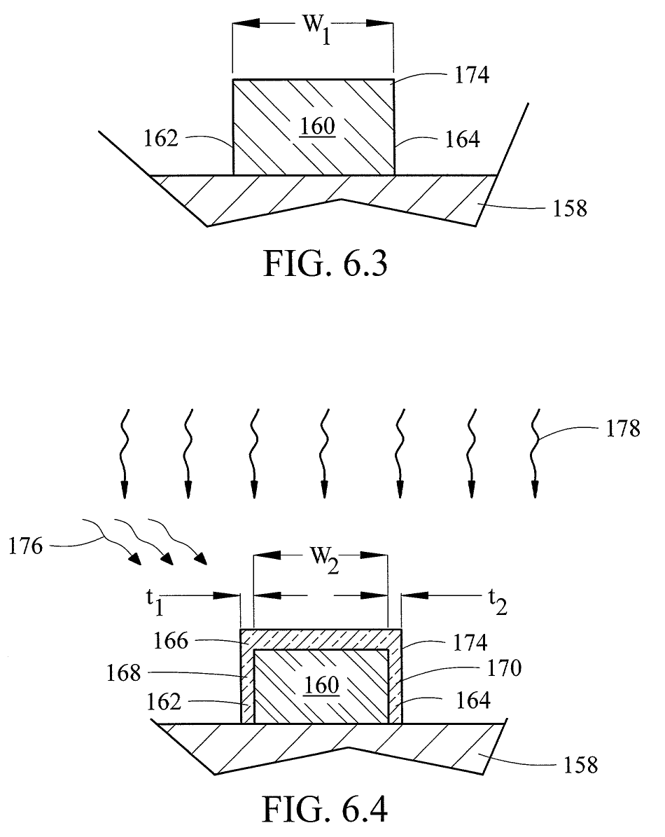

FIGS. 6.1-6.4 illustrate a method of forming writer pole 154 of a write element 134 in accordance with an embodiment of the invention. FIGS. 6.1-6.3 illustrate an example of one method that can be used to form writer pole 154 on non-magnetic layer 158. Those skilled in the art will appreciate that other methods can be used to form the non-magnetic layer 158 and the general structure of the writer pole 154. As shown in FIG. 6.1, following the formation of non-magnetic layer 158, photoresist dams 172 are formed on top surface 156 of non-magnetic layer 158. Next, a writer pole portion 174 is formed between photoresist dams 172 using a deposition or electroplating process, as shown in FIG. 6.2. Photoresist dams 174 are then removed thereby exposing writer pole portion 174 including first and second side walls 162 and 164 as shown in FIG. 6.3. At this stage of the manufacturing process, writer pole portion 174 has an active region 160 whose width is equal to the physical width W₁ of writer pole portion 174.

FIG. 6.4 illustrates the step of transforming exterior portions of the magnetically active region 160 into a magnetically dead region 166 by irradiating or ion implanting elements therein. In accordance with the embodiment of write pole 154 depicted in FIG. 4, the exposure of second side wall 164 to the elements is avoided by directing the elements at an angle toward first side wall 162, as indicated by arrows 176. This allows the formation of only first magnetically dead side wall 168. Alternatively, temporary insulating layers (not shown) that are adapted to absorb or block the elements, could be formed over second side wall 164 or other surfaces of writer pole portion 174 where transformation to a magnetically dead region is undesired. Alternatively, the heavy elements can be directed toward all of the exposed surfaces of writer pole portion 174 including first and second side walls 162 and 164, as indicated by arrows 178, to thereby form first and second magnetically dead side walls 168 and 170 and the write pole 154 depicted in FIG. 5.

Those skilled in the art will appreciate that ion implantation or irradiation techniques can be used to implant elements in exposed surfaces of writer pole 154 to form the magnetically dead region 166. The elements that are implanted in writer pole 154 could be nitrogen, argon, boron, phosphorous, gallium, or almost any other element that can transform selected portions of the magnetically conductive material forming writer pole portion 174 into a magnetically dead material 166.

In summary, one aspect of the present invention is directed to a method of forming a narrow writer pole (such as 154) of a write element (such as 134) for use in a head (such as 130) of a disc drive storage system (such as 100). The method generally involves forming a writer pole portion (such as 174) on a non-magnetic layer (such as 158, 140 or 152). The writer pole portion includes first and second side walls (such as 162 and 164) which initially define a width (such as W₁) of a magnetically active region (such as 160). The non-magnetic layer and the writer portion can be formed in accordance with processing methods, such as photolithography, electroplating, milling, and etching. In accordance with one embodiment of the invention, the first side wall is transformed into a magnetically dead side wall (such as 168). This reduces the width of the magnetically active region by the thickness (such as t₁) of the first magnetically dead side wall and results in the formation of a writer pole having a track width (such as W₂) that is narrower than the physical width (such as W₁) of the writer pole.

In accordance with another embodiment, both the first and second side walls are transformed into magnetically dead side walls (such as 168 and 170) to thereby reduce the width of the magnetically active region (such as W₂) to a dimension that is less than the physical width (such as W₁) of the writer pole 154 by the thicknesses of the first and second magnetically dead side walls (such as t₁ and t₂).

The method of transforming the first and/or second side walls of the writer pole 154 into magnetically dead side walls is preferably accomplished by irradiating or ion implanting an element (such as 176 and 178) into those surfaces. The element can be nitrogen, argon, boron, phosphorous, gallium, or other suitable elements.

Another embodiment of the present invention is directed to a write element (such as 134) for use in a head (such as 130) of a disc drive storage system (such as 100). The write element includes a return pole (such as 136 or 138), a writer gap layer (such as 140) adjacent the return pole, and a writer pole (such as 154) separated from the return pole by the writer gap layer. The writer pole includes a magnetically active region (such as 160) that adjoins a first magnetically dead side wall (such as 168). The magnetically active region defines a track width (such as W₂) of the writer element, which is approximately a physical width (such as W₁) of the writer pole 154 less a thickness (such as t₁) of the first magnetically dead side wall. In accordance with another embodiment of the invention, the magnetically active region of the write element is further reduced by a thickness (such as t₂) of a second magnetically dead side wall (such as 170) that is opposite the first magnetically dead side wall. The magnetically dead side walls are formed of a magnetic material that is implanted with an element (such as 176 and 178) such as nitrogen, argon, boron, phosphorous or gallium.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, although the embodiments described herein are directed to a recording element for use in a head of a disc drive storage system, it will be appreciated by those skilled in the art that the teachings of the present invention can be applied to other systems without departing from the scope and spirit of the present invention.

What is claimed is:

1. A method of forming a narrow writer pole of a write element, the method comprising steps of:
(a) forming a non-magnetic layer;
(b) forming a writer pole portion on the non-magnetic layer having first and second side walls which define a width of a magnetically active region, the width of the magnetically active region defining a track width of the write element; and
(c) transforming the first side wall into a magnetically dead side wall thereby reducing the width of the magnetically active region and the track width of the write element by a thickness of the magnetically dead first side wall.

2. The method of claim 1, including a step (d) of transforming the second side wall into a magnetically dead side wall thereby further reducing the width of the magnetically active region and the track width of the write element by a thickness of the magnetically dead second side wall.

3. The method of claim 1, wherein the forming step (b) is performed in accordance with at least one process selected from a group consisting of sputter deposition, photolithography, etching, milling, and electroplating.

4. The method of claim 1, wherein the transforming step (c) is performed in accordance with at least one process selected from a group consisting of irradiation and ion implantation.

5. The method of claim 4, wherein an element used in ion implantation is selected from a group consisting of nitrogen, argon, boron, phosphorous, and gallium.

6. The method of claim 2, wherein the transforming steps (c) and (d) are performed in accordance with at least one process selected from a group consisting of irradiation and ion implantation.

7. The method of claim 6, wherein an element used in ion implantation is selected from a group consisting of nitrogen, argon, boron, phosphorous, and gallium.

8. The method of claim 1, wherein the forming step (b) includes:
(b)(1) forming photoresist dams on the non-magnetic layer;
(b)(2) forming the writer pole portion between the photoresist dams; and
(b)(3) removing the photoresist dams.

9. The method of claim 1, wherein the writer pole is either a top pole or a bottom pole of the write element.

10. A write element comprising:
a return pole;
a writer gap layer adjacent the return pole; and
a writer pole separated from the return pole by the writer gap layer and having a width and a magnetically active region adjoining a first magnetically dead side wall;
wherein the magnetically active region defines a width of the write element, which is less than a width of the writer pole.

11. The write element of claim 10, including a second magnetically dead side wall opposite the first magnetically dead side wall and having a thickness, whereby the width of the write element is the width of the writer pole less the thicknesses of the first and second magnetically dead side walls.

12. The write element of claim 10, wherein the first magnetically dead side wall is formed of a magnetic material implanted with an element selected from a group consisting of nitrogen, argon, boron, phosphorous, and gallium.

13. The write element of claim 11, wherein the first and second magnetically dead side walls are formed of a magnetic material implanted with an element selected from a group consisting of nitrogen, argon, boron, phosphorous, and gallium.

14. The write element of claim 10, wherein the writer pole is either a bottom pole or a top pole.

15. A disc drive storage system including the write element of claim 10.

16. A write element comprising:
a writer gap layer formed adjacent a return pole;
a writer pole formed adjacent the writer gap layer opposite the return pole and having an active region whose width defines a width of the write element; and
an active region reducing means for reducing the width of the active region without reducing a width of the writer pole.

17. The write element of claim 16, wherein the active region reducing means includes at least one magnetically dead side wall adjoining the active region.

18. The write element of claim 17, wherein the magnetically dead side wall is formed of a magnetic material implanted with an element selected from a group consisting of nitrogen, argon, boron, phosphorous, and gallium.

19. A disc drive storage system including the write element of claim 16.
